(19) United States
(12) Patent Application Publication
(10) Pub. No.: US 2010/0263246 A1
(43) Pub. Date: Oct. 21, 2010

(54) TRANSPARENT SIGNBOARD AND FABRICATING METHOD THEREOF

(76) Inventors: Sang Keun Oh, Seongnam-si (KR); Do Hyeong Park, Gwangju-si (KR); Yeo Hwan Yoon, Seoul (KR)

Correspondence Address: KED & ASSOCIATES, LLP, P.O. Box 221200, Chantilly, VA, 20153-1200, US

(21) Appl. No.: 12/741,411

(22) PCT Filed: Mar. 20, 2008
(86) PCT No.: PCT/KR08/01571

§ 371 Date: May 5, 2010

(30) Foreign Application Priority Data
Nov. 7, 2007 (KR) 10-2007-0113049

(51) Int. Cl. G09F 13/08; B05D 5/06; B05D 3/06

(52) U.S. Cl. 40/541; 427/64; 427/555

(57) ABSTRACT

A transparent signboard and a method for fabricating the same are provided. The transparent signboard includes: a transparent substrate; an electrode layer made of polymer or carbon nanotube and comprising a plurality of conducting parts separated from each other with respect to a predetermined pattern region interposed therebetween, and a non-conducting part formed on the predetermined pattern region and integrally formed with the conducting parts; and a light-emitting device configured to connect the separated conducting parts to each other.

### TECHNICAL FIELD

The present invention relates to a transparent signboard and a method for fabricating the same and, more particularly, to a transparent signboard used for lighting or indoor/outdoor advertising and a method for fabricating the same.

### BACKGROUND ART

A transparent signboard includes a glass substrate, a thin metal film patterned on the glass substrate to form an electrode, and a light-emitting device connected to the patterned electrode. The patterned electrode is connected at its both ends to positive and negative terminals, and makes a light-emitting device emit light upon connection to the light-emitting device.

Typically, the light-emitting device is a light-emitting diode (LED) and the patterned electrode is made of indium tin oxide (ITO).

A method for patterning the thin metal film typically includes applying an ITO thin film on a glass substrate, irradiating a laser beam to form ITO thin films separated with a predetermined pattern, connecting a power supply so that the separated ITO thin films have different polarities, and connecting terminals of a light-emitting device to each of the separated ITO thin film.

### DISCLOSURE OF INVENTION

### Technical Problem

According to the prior art, the ITO thin film needs to be coated on the entire substrate of the transparent signboard, thus costing too much.

In addition, the ITO thin film is coated in vacuum, thus limiting the size of a glass substrate. Besides, the ITO thin film is weak in repetitive bending and is heavy.

Furthermore, a metal such as ITO is brittle. Recently, since a transparent signboard is formed to have a curved surface, an electrode pattern is fragile.

### Technical Solution

The present invention provides a flexible, light transparent signboard and a method for fabricating the same.

The present invention also provides a transparent signboard and a method for fabricating the same, which is capable of forming an electrode pattern conveniently and accurately at low cost.

### ADVANTAGEOUS EFFECTS

According to the present invention, it is possible to form an electrode pattern on a transparent substrate with a variety of structures and types since the electrode pattern can be formed by coating carbon nanotube on the transparent substrate.

Furthermore, since a variety of types of electrode patterns can be conveniently formed, it is possible to fabricate a transparent signboard conveniently and inexpensively, thereby embodying a variety of types of advertising images.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a transparent signboard according to a first exemplary embodiment of the present invention;

FIG. 2 is a cross-sectional view taken along the line II-II of FIG. 1;

FIG. 3 is a flow chart of a method for fabricating a transparent signboard of FIG. 1;

FIG. 4 is a perspective view of a transparent substrate in a process of performing a method for fabricating a transparent signboard shown in FIG. 3;

FIG. 5 is a perspective view of a transparent substrate and an electrode layer in a process of performing a method for fabricating a transparent signboard shown in FIG. 3;

FIG. 6 is a perspective view of a deactivated electrode layer in a process of performing a method for fabricating a transparent signboard shown in FIG. 3;

FIG. 7 is a perspective view of a light-emitting device configured to connect separated electrode layers in a process of performing a method for fabricating a transparent signboard shown in FIG. 3;

FIG. 8 is a cross-sectional view of a transparent signboard according to a second exemplary embodiment of the present invention;

FIG. 9 is a plan view of a transparent signboard according to a second exemplary embodiment of the present invention;

FIG. 10 is a perspective view of a transparent signboard shown in FIG. 9;

FIG. 11 is a picture of carbon nanotube which is not formed in a mesh pattern;

FIG. 12 is a picture of carbon nanotube which is formed in a mesh pattern;

FIG. 13 is a plan view of a transparent signboard according to a third exemplary embodiment of the present invention;

FIG. 14 is a plan view of a transparent signboard according to a fourth exemplary embodiment of the present invention;

FIG. 15 is a plan view of a transparent signboard according to a fifth exemplary embodiment of the present invention;

FIG. 16 is a plan view of a transparent signboard according to a sixth exemplary embodiment of the present invention;

FIG. 17 is a plan view of a transparent signboard according to a seventh exemplary embodiment of the present invention; and

FIG. 18 is a plan view of a transparent signboard according to an eighth exemplary embodiment of the present invention.

### BEST MODE FOR CARRYING OUT THE INVENTION

According to an aspect of the present invention, there is provided a transparent signboard including: a transparent substrate; an electrode layer made of polymer or carbon nanotube and including a plurality of conducting parts separated from each other with respect to a predetermined pattern region interposed therebetween, and a non-conducting part formed on the predetermined pattern region and integrally formed with the conducting parts; and a light-emitting device configured to connect the separated conducting parts to each other.

The polymer of the electrode layer may be conductive, and the non-conducting part of the electrode layer may be made non-conductive by deactivating conductive property of the polymer.

The polymer of the electrode layer may be made of at least one of polyparaphenylene (PPP), polypyrole (PPy), polythiophene (PT), polyisothianaphthene (PITN), polyaniline (PANI), and their derivatives.

The non-conducting part of the electrode layer may further include non-conductive, transparent polymer, such as acryl, urethane, melamine, epoxy, and their derivatives, in addition to the polymer of the electrode layer.

According to another aspect of the present invention, there is provided a method for fabricating a transparent signboard, including: preparing a transparent substrate; forming an electrode layer made of conductive polymer on the transparent substrate; deactivating conductive property of the electrode layer on a predetermined pattern region; and forming a light-emitting device configured to connect electrode layers separated from each other with respect to the predetermined pattern region.

The deactivating of conductive property of the electrode layer on a predetermined pattern region may include coating ink to deactivate the conductive property of the electrode layer on the predetermined pattern region.

The method may further include drying or removing the ink following the coating of the ink.

The conductive polymer may be polyparaphenylene (PPP), polypyrole (PPy), polythiophene (PT), polyisothianaphthene (PITN), polyaniline (PANI), or their derivatives, and the ink may be one of typical oxidants, such as sodium hypochlorite, sodium chlorite, perchloric acid (HClO₄), hydrogen peroxide (H₂O₂), sodium perborate, and sodium peroxide.

According to another aspect of the present invention, there is provided a transparent signboard including: a transparent substrate; an electrode pattern formed on the transparent substrate and made of carbon nanotube; and a light-emitting device configured to be connected to the electrode pattern.

### MODE FOR THE INVENTION

Exemplary embodiments in accordance with the present invention will now be described in detail with reference to the accompanying drawings.

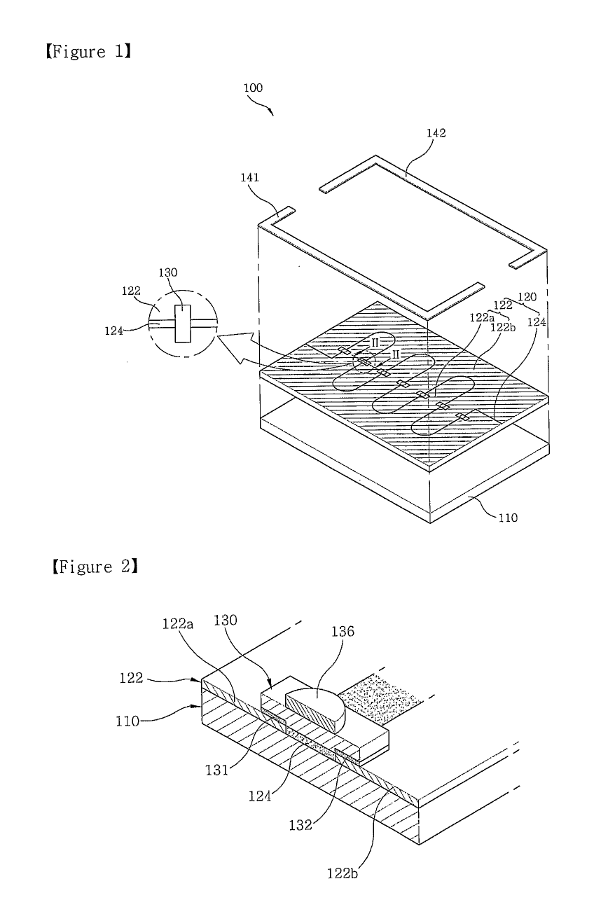

FIG. 1 is a perspective view of a transparent signboard according to a first exemplary embodiment of the present invention. FIG. 2 is a cross-sectional view taken along the line II-II of FIG. 1.

The transparent signboard 100 includes a transparent substrate 110, an electrode layer 120, and a light-emitting device 130. The transparent signboard refers to a display, such as a transparent billboard, which presents visual information.

The transparent substrate 110 is formed of glass, transparent polymer or flit glass.

The transparent substrate 110 is preferably formed of a high-transparent inorganic substrate or a transparent polymer substrate.

The electrode layer 120 is made of polymer and is formed on the transparent substrate 110. The electrode layer 120 includes a plurality of conducting parts 122 and a non-conducting part 124. The plurality of conducting parts 122 are separated from each other with respect to a predetermined pattern region. The non-conducting part 124 is formed on the predetermined pattern region. The conducting parts 122 and the non-conducting part 124 are integrally formed together.

The electrode layer 120 is made of polymer and is thus highly flexible. Since the conducting parts 122 and the non-conducting part 124 are integrally formed together, the light-emitting device is more stably placed on the electrode layer 120, and the transparent signboard 100 does not look stained when seen from the outside and increases in durability.

The polymer of the electrode layer 120 is preferably conductive, and the polymer of the non-conducting part 124 is preferably deactivated to be non-conductive.

Since the conductive polymer is highly flexible, the transparent signboard 100 made of the conductive polymer is not fragile when bent. Additionally, the conductive polymer is lighter, lower in cost and thinner than metal.

The conductive polymer typically has a surface resistance as large as 100 ohms/sq or more. Accordingly, the conductive polymer needs to be used as a surface electrode. That is, the predetermined pattern is formed of conductive polymer, and the conductive polymer is electrically connected to a positive terminal or a negative terminal to be used as an electrode.

Accordingly, the conductive polymer is coated on the transparent substrate except the predetermined pattern region. That is, the conductive polymer is not formed on the pattern, and the light-emitting device is configured to electrically connect the conductive polymers formed on both sides of the pattern which is interposed between the conductive polymers.

In this case, comparing with a method for forming an electrode pattern on an ITO thin film, it is easier, faster, less expensive, and larger in area to form the conductive polymer on the transparent substrate except the predetermined pattern region. However, the transparent substrate exposed on the pattern region makes it difficult to safely place the light-emitting device, may make the transparent signboard look stained when seen from the outside, and makes the durability of the transparent signboard lower. Accordingly, the exposed transparent substrate on the pattern region needs to additionally be coated with non-conducting material.

Accordingly, the electrode layer 120 formed on the transparent signboard 100 is configured to include a plurality of conducting parts 122, which are separated from each other by the predetermined pattern region interposed therebetween, and a non-conducting part 124, which is formed on the pattern region and is integrally formed with the conducting parts 123. Accordingly, since the non-conducting part 124 does not need to be removed from the electrode layer 120, for example, by etching, it is possible to easily, stably place the light-emitting device 130. In addition, the durability of the transparent signboard 100 does not lower and the light-emitting performance of the transparent signboard 100 becomes excellent.

In this case, the electrode layer 120 is made of conductive polymer, and the non-conducting part 124 of the electrode layer 120 may be formed of non-conductive polymer by deactivating the conductive property of the polymer. That is, the non-conducting part 124 may be formed by coating a conducting layer made of conductive polymer on the transparent substrate 110, and deactivating the conductive property of conductive polymer formed on the pattern region. The conductive polymer may be made of at least one of polyparaphenylene (PPP), polypyrole (PPy), polythiophene (PT), polyisothianaphthene (PITN), polyaniline (PANI), and their derivatives.

The deactivation may be performed by coating ink on the pattern region of the conductive polymer by screen masking. The ink deactivates the conductive property of the conductive polymer, and is made of a typical oxidant, such as sodium hypochlorite, sodium chlorite, perchloric acid (HClO₄), hydrogen peroxide (H₂O₂), sodium perborate, and sodium peroxide. That is, the ink is deposited after a mask with a predetermined pattern is provided on the transparent substrate 110. In addition to the screen masking, screen printing, spray coating, gravure printing, or offset printing may be used.

Once the ink is coated on the pattern region of the conductive polymer, the ink reacts with the conductive polymer on the pattern region to deactivate the conductive property of the conductive polymer.

In one embodiment, if PEDOT (poly(3,4-ethylenedioxythiophene), a derivative of polythiophene, is used as the conductive polymer and hydrogen peroxide (H₂O₂) is used as an oxidizing ink, monomer of thiophene, which maintains the conductive property, is transformed to thiophene dioxide by the oxidant, and oxyethylene ring is oxidized, thereby deactivating the conductive property of the polymer.

The conducting parts 122 separated from each other by the pattern are connected to each other by the light-emitting device 130. Examples of the light-emitting device 130 include light-emitting diodes (LED), laser diodes, organic electroluminescence (EL), liquid crystal devices (LCD), and field emission devices (FED).

In a case of an LED as the light-emitting device 130, a first electrode 131 of the LED is connected to a first conducting part 122a neighboring one end of a non-conducting part 124, and a second electrode 132 of the LED is connected to a second conducting part 122b neighboring the other end of the non-conducting part 124. When the first and second conducting parts 122a and 122b are connected to each other by the electrodes 131 and 132, and positive and negative voltage sources 141 and 142 supply electronic signals to the first and second conducting parts 122a and 122b, a light-emitting part 136 of the LED emits light.

In this case, the electrodes of the light-emitting device 130 may be attached with a conductive adhesive or directly to the conducting parts.

In this case, the conductive adhesive may generally be made by dispersing metal, such as silver or nickel, and conductive filler, such as conductive carbon, into organic resin. In particular, nano-sized metal particles may be low-temperature sintered to reduce contact resistance between the particles, thereby stably connecting the conducting part 122 to the light-emitting device.

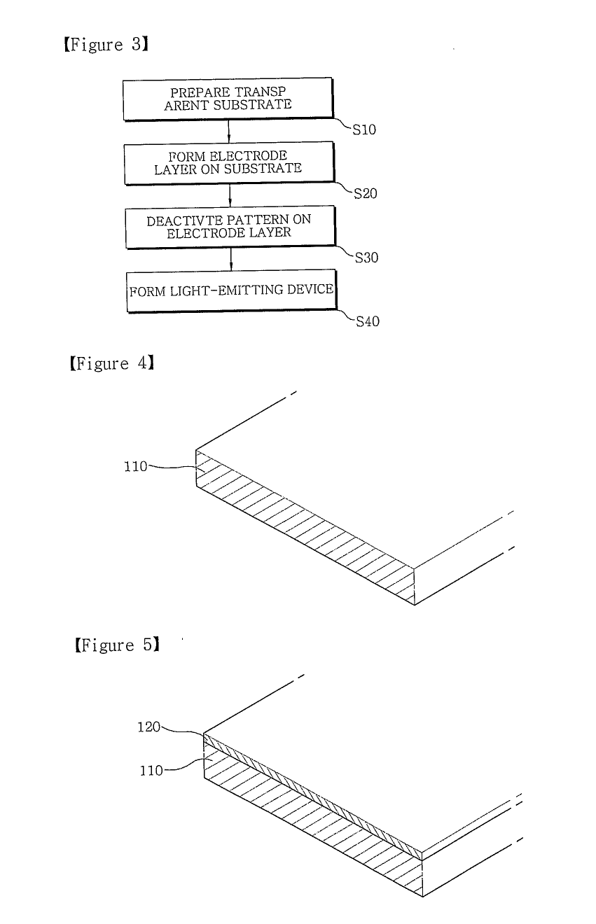

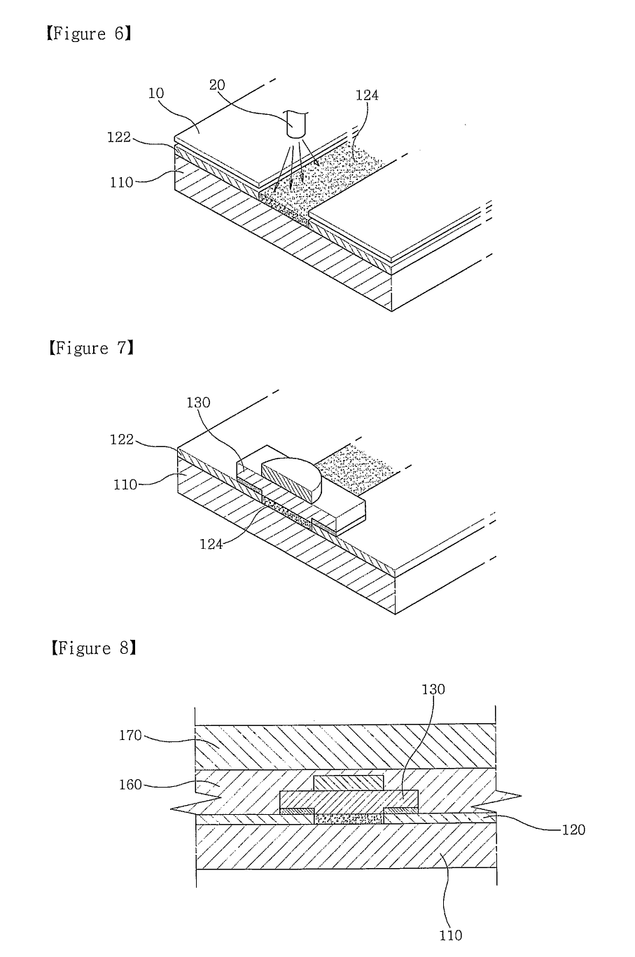

FIG. 3 is a flow chart of a method for fabricating a transparent signboard according to an exemplary embodiment of the present invention. FIGS. 4 to 7 are cross-sectional views of the transparent signboard in each operation of fabricating the transparent signboard.

The method for fabricating the transparent signboard 100 will be described with reference to FIGS. 3 to 7.

The method includes preparing a transparent substrate 110 in operation S10, forming an electrode layer 120 made of conductive polymer on the transparent substrate 110 in operation S20, deactivating the conductive property of the electrode layer 120 on a predetermined pattern region in operation S30, and forming a light-emitting device 130 in operation S40 so that the electrode layers 120 separated from each other by the pattern can be connected to each other.

The operation S30 may be performed by forming a screen mask 10 on the pattern region of the electrode layer 120 and depositing an ink 20 which deactivates the pattern region of the electrode layer 120 to make it non-conductive.

In addition, the operation S30 may be performed by applying a laser beam to the pattern region of the electrode layer 120 to deactivate the conductive property.

Furthermore, the operation S30 may be performed by etching the pattern region of the electrode layer 120 with a knife to remove the conductive property of the pattern region.

The electrode layer 120 is divided into the conducting part 122 and the non-conducting part 124 by the operation S30.

In this case, the coating of the ink may be further followed by drying or removing the ink.

As shown in FIG. 8, the transparent signboard 100 may further include a supplemental substrate 170, which faces the transparent substrate 110, and a filler layer 160, which is disposed between the transparent substrate 110 and the supplemental substrate 170 to cover the light-emitting device 130. The supplemental substrate 170 is made of transparent material as the transparent substrate 110. The filler layer 160 is disposed between the transparent substrate 110 and the supplemental substrate 170.

The filler layer 160 is formed between the transparent substrate 110 and the supplemental substrate 170. The filler layer 160 is formed to cover the electrode layer 120 and the light-emitting device so that the filler layer 160 can protect the electrode layer 120 and the light-emitting device from moisture and absorb impact from the outside.

The filler layer 160 is made of transparent, adhesive polymer to be attached to the transparent substrate 110 and the supplemental substrate 170. The electrode pattern and the light-emitting device 130 can be protected from external impact by the filler layer 160 between the transparent substrate 110 and the supplemental substrate 170.

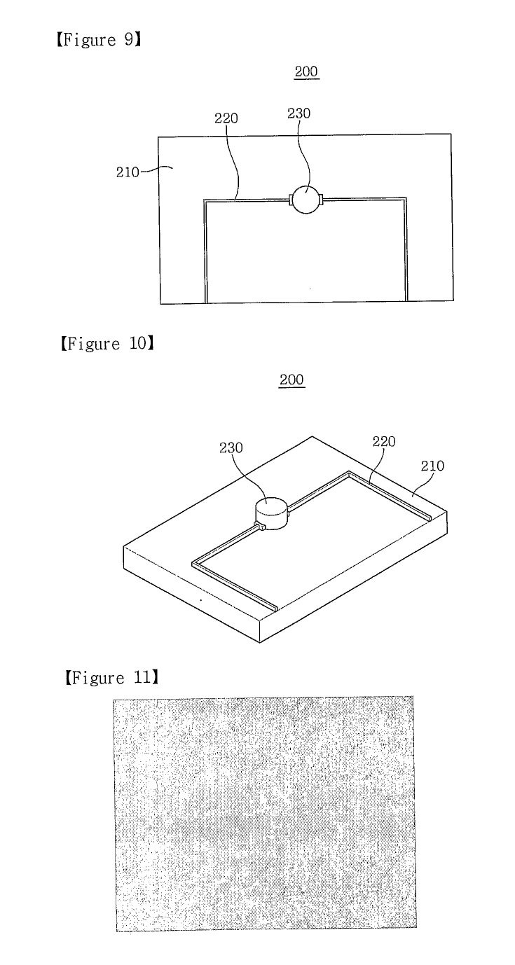

FIGS. 9 and 10 are a plan view and a perspective view, respectively, of the transparent signboard 200 according to a second exemplary embodiment of the present invention.

The transparent signboard 200 includes a transparent substrate 210, an electrode pattern 220, and a light-emitting device 230. In this case, the electrode pattern 230 is formed on the transparent substrate 210 and is made of carbon nanotube. The light-emitting device 230 is electrically connected to the electrode pattern 220.

The transparent pattern 210 may be formed of a transparent inorganic substrate or a transparent polymer substrate.

The electrode pattern 220 is formed by coating carbon nanotube ink on a substrate by a thickness of 1 nm to 1 μm. Transparency and conductivity depends upon the coating thickness. The carbon nanotube ink may include a binder with a good bonding strength for bonding with the transparent substrate.

The carbon nanotube is several nanometers in diameter and hundreds to thousands nanometers in length. The carbon nanotube may be one selected from among a group of single-wall nanotube, double-wall nanotube, and multi-wall nanotube.

Conductive metal may be attached on the carbon nanotube. The conductive metal may be one selected from among a group of gold (Au), silver (Ag), copper (Cu), iron (Fe), aluminum (Al), chromium (Cr), titanium (Ti), platinum (Pt), and palladium (Pd), or their combination.

In addition, conductive material may be attached on the carbon nanotube. In this case, the conductive material may be one selected from among a group of antimony tin oxide (ATO), indium tin oxide (ITO), indium zirconium oxide (IZO) and ZnO, or their combination. The conductive metal or conductive material attached on the carbon nanotube makes the electrode pattern 220 with higher conductivity.

In order to form a thin film of carbon nanotube, the carbon nanotube dispersed in a solution needs to be transferred in a mesh pattern to the transparent substrate. In this case, the length of the carbon nanotube, the surface condition of the substrate, and the drying time of the solution may be adjusted.

For more effective formation of carbon nanotube, the carbon nanotube is 5 μm or more long in the present exemplary embodiment. In this case, it is possible to reliably form the carbon nanotube in a mesh pattern.

If the length of the carbon nanotube is too short, the carbon nanotube may not be formed properly in a mesh pattern as shown in FIG. 11. Thus, the carbon nanotube of 5 μm in length is appropriate for forming it in a mesh pattern as shown in FIG. 12.

The surface of the transparent substrate may be made hydrophilic to efficiently form the carbon nanotube in a mesh pattern. If the surface of the transparent substrate is made hydrophilic, for example, by plasma processing, a contact angle between the carbon nanotube ink and the transparent substrate decreases, thereby forming the carbon nanotube in a mesh pattern without tangling.

On the other hand, the surface of the carbon nanotube may be made hydrophobic. In this case, since the transparent substrate made hydrophobic prevents ink from spreading, it is possible to obtain a clearer electrode pattern. In this case, however, the carbon nanotube needs to be long enough, thereby stably forming the carbon nanotube in a mesh pattern even though the surface of the transparent substrate is made hydrophobic.

Referring back to FIG. 10, the electrode pattern 220 preferably has a transparency of 10% to 99% and a surface resistance ranging from 1Ω/□ to 1MΩ/□.

The electrode pattern 220 with its surface resistivity may be set to have a wide range of resistances depending on the length and thickness of the electrode pattern. However, an electrode pattern with a surface resistance of less than 1Ω/□ may break a light-emitting device due to too large voltage applied to the light-emitting device. An electrode pattern with a surface resistance of more than 1MΩ/□ may not turn on a light-emitting device due to too small current applied to the light-emitting device.

The electrode pattern 220 is formed to have a line thickness of 110 μm or smaller by inkjet printing. The present embodiment exemplifies a method for forming the electrode pattern by inkjet printing. However, the electrode pattern may be formed by screen printing, offset printing, etc.

In the present embodiment, LED is used as the light-emitting device 230. However, other light-emitting devices, such as a laser diode, an organic EL, a field emission device, and an E-paper, may be used.

Therefore, according to the present embodiment, it is possible to efficiently use the conductive property of the carbon nanotube by forming the electrode pattern 220 on the transparent substrate 210. In addition, it is possible to minimize the amount of the carbon nanotube upon forming the electrode pattern.

The carbon nanotube makes it possible to form an electrode pattern with a precision as high as several micrometers or smaller and to form a wide electrode pattern. Furthermore, it is possible to address limitations in electrode design for complex images by applying a laser beam to the ITO thin film.

The electrode pattern may be made to have a width of 1 nm to 100 μm so as not to be easily noticed, or may be made to have a width of 1 nm to 1 μm to be transparent enough.

If the electrode pattern is smaller than 1 nm wide or thick, the carbon nanotube is not properly formed in a mesh pattern, thus increasing resistance or preventing current flowing. If the electrode pattern is larger than 100 μm wide and larger than μm thick, the transparency of the electrode pattern decreases, thus easily noticed.

The transparency may be improved by decreasing the coating thickness as described above. Since the transparency is generally inversely proportional to the coating thickness and is proportional to the surface resistance, the coating thickness needs to be selected taking into account the transparency and resistance.

A method for fabricating the transparent signboard 200 according to a second exemplary embodiment of the present invention will be described.

First, a transparent substrate 210 is prepared. The surface of the transparent substrate 210 may be made either hydrophilic or hydrophobic depending upon the type and structure of carbon nanotube. Next, ink containing the carbon nanotube is coated on the transparent substrate 210 to form an electrode pattern 220. In this case, since material other than the carbon nanotube may remain on the transparent substrate 210, high-temperature heat treatment is performed to remove the other material. The heat treatment may be performed around 100° C. to 600° C., which may vary depending upon the type of the transparent substrate 210.

After forming the electrode pattern 220, a light-emitting device 230 is provided to be electrically connected to the electrode pattern 220.

Accordingly, the transparent signboard is formed conveniently by coating the carbon nanotube on the transparent substrate and connecting the light-emitting device to the transparent substrate.

The carbon nanotube electrode pattern may be adjusted to have a transparency of 10% to 99% according to the ink concentration and the coating frequency. In this case, its resistance can also be adjusted.

Compared to spray coating or screen printing, the inkjet printing is performed with a simple process since it is possible to form a fine pattern without a mask.

Furthermore, the inkjet printing is most appropriate for small quantity batch production by spraying ink on the transparent substrate to form a variety of patterns.

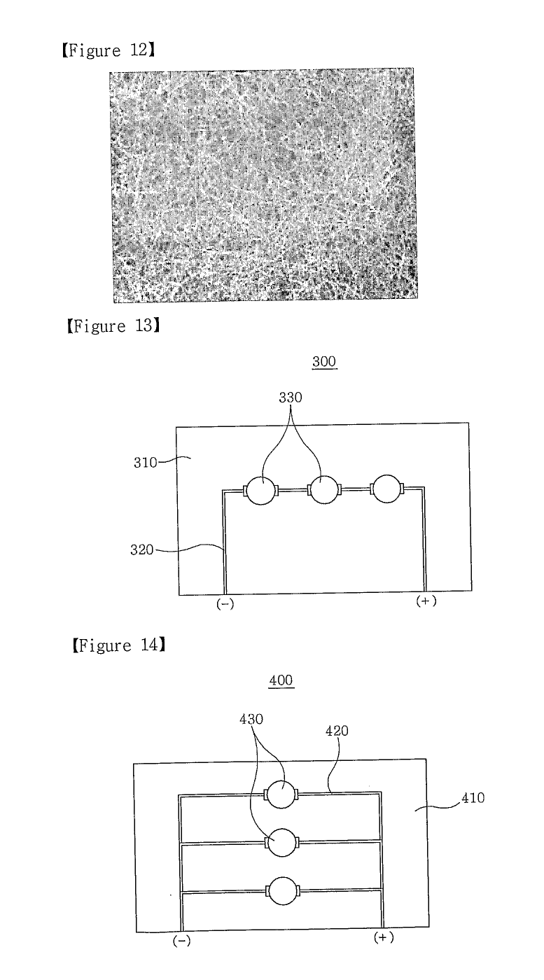

FIG. 13 is a plan view of a transparent signboard 300 according to a third exemplary embodiment of the present invention.

The transparent signboard 300 includes a transparent substrate 310, an electrode pattern 320 formed on the transparent substrate 310, and a light-emitting device 330 electrically connected to the electrode pattern 320.

The electrode pattern 320 is made of carbon nanotube. A plurality of light-emitting devices are connected in series by the electrode pattern. An LED is used as the light-emitting device.

The light-emitting devices 320 connected in series are turned on with a power source. However, it is difficult to accurately apply voltage to the light-emitting devices. In particular, since an LED varies in its operating voltage depending on temperature and has a small resistance, the LED may break due to overcurrent when a voltage exceeding an appropriate voltage is applied. Thus, an overcurrent protecting resistor is provided between the power source and the LED to prevent overcurrent from being applied to the LED.

However, the electrode pattern 320 using carbon nanotube has a resistance of hundreds of ohms, which prevents overcurrent from flowing through the light-emitting device. Therefore, an extra resistor is not needed.

FIG. 14 is a plan view of a transparent signboard 400 according to a fourth exemplary embodiment of the present invention.

The transparent signboard 400 includes a transparent substrate 410, an electrode pattern 420 formed on the transparent substrate 410, and a light-emitting device 430 electrically connected to the electrode pattern 420.

The electrode pattern 420 is made of carbon nanotube. A plurality of light-emitting devices 430 are connected in parallel to one another by the electrode pattern 430. An LED is used as the light-emitting device 430.

Since the light-emitting devices 430 connected in parallel each has a uniform voltage, it is convenient to apply a desired voltage to the light-emitting devices 430 even though a fine electrode pattern is formed. Accordingly, in this case, it is possible to form an electrode pattern as fine as unnoticeable.

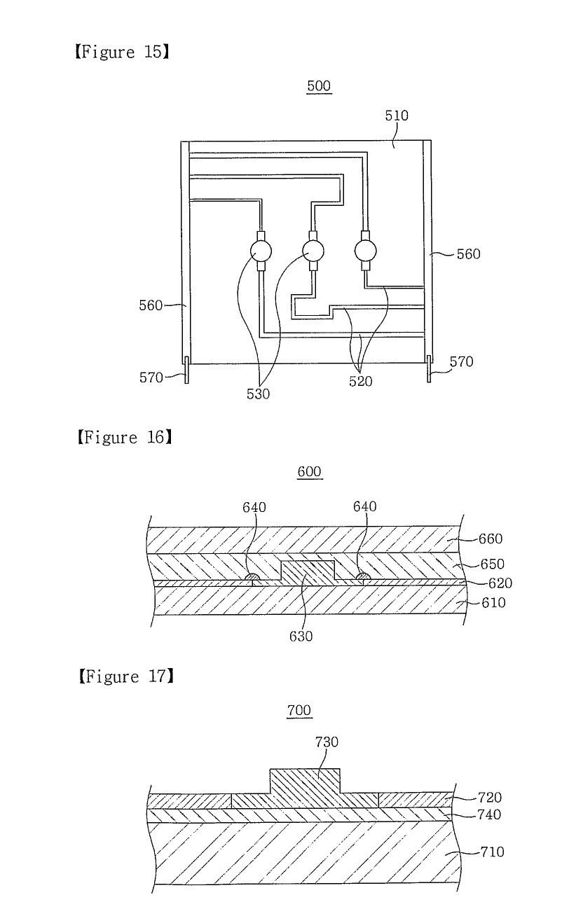

FIG. 15 is a plan view of a transparent signboard 500 according to a fifth exemplary embodiment of the present invention.

The transparent signboard 500 includes a transparent substrate 510, metal electrodes 560 formed across the transparent substrate 510, and a light-emitting device 530 formed on the transparent substrate 510, and an electrode pattern 520 formed on the transparent substrate 510 to connect the light-emitting device 530 to the metal electrodes 560.

The metal electrodes 560 are provided across the transparent substrate 510, and are made of silver (Ag) or platinum (Pt) having a low resistance. Each metal electrode 560 has a terminal 570 to be connected at its one end to a power source.

The electrode pattern 520 is made of carbon nanotube. Each electrode pattern 520 between the metal electrode 560 and the light-emitting device 530 has the same resistance to apply the same voltage to each light-emitting device 530. Accordingly, the electrode pattern 520 may be configured to have the same resistance between the metal electrode 560 and the light-emitting device 530 by adjusting the thickness or length of the electrode pattern 520. That is, if a distance between the metal electrode 560 and the light-emitting device 530 is short, the width of the electrode pattern 520 is made thin to increase its resistance. If the distance is long, the width of the electrode pattern 520 is made wide to reduce its resistance. Otherwise, the length of the electrode pattern 520 is made long while its width remains unchanged, in order to increase its resistance.

FIG. 16 is a cross-sectional view of a transparent signboard 600 according to a sixth exemplary embodiment of the present invention.

The transparent signboard 600 includes a transparent substrate 610, an electrode pattern 620 formed on the transparent substrate 610, a light-emitting device 630 electrically connected to the electrode pattern 620, a supplemental substrate 660 facing the transparent substrate 610, and a filler layer 650 disposed between the transparent substrate 610 and the supplemental substrate 660 to cover the light-emitting device 630.

The electrode pattern 620 and the light-emitting device 630 are formed on the transparent substrate 610. The transparent substrate 610, the electrode pattern 620, and the light-emitting device 630 are configured in the same manner as those of the second embodiment, and a detailed description thereof will thus be omitted herein.

The light-emitting device 630 and the electrode pattern 620 are connected to each other with a conductive adhesive 640 having a small resistance and an excellent adhesion. The conductive adhesive 640 is typically made by dispersing metal, such as silver and nickel, and conductive filler, such as conductive carbon, in organic resin. In particular, nano-sized metal particles may be low-temperature sintered to reduce contact resistance between the particles, thereby stably connecting the electrode pattern to the light-emitting device.

The supplemental substrate 660 is formed on the light-emitting device 630 in parallel with the transparent substrate 610. The supplemental substrate 660 is made of a transparent material similarly to the transparent substrate.

The filler layer 650 is formed between the transparent substrate 610 and the supplemental substrate 660 to cover the electrode pattern 620 and the light-emitting device 630. The filler layer 650 protects the electrode pattern 620 and the light-emitting device 630 from external environment, such as moisture, and absorbs impact from the outside to protect electronic elements.

The filler layer 650 is made of a transparent, adhesive material, such as polymer, to be attached to the transparent substrate and the supplemental substrate.

Therefore, according to the present embodiment, the electrode pattern 620 and the light-emitting device are stably electrically connected to each other with the conductive adhesive. Furthermore, the filler layer 650 disposed between the transparent substrate and the supplemental substrate protects the electrode pattern and the light-emitting device from external impact.

FIG. 17 is a cross-sectional view of a transparent signboard 700 according to a seventh exemplary embodiment of the present invention.

The transparent signboard 700 includes a transparent substrate 710, an adhesive layer 740 formed on the transparent substrate 710, an electrode pattern 720 formed on the adhesive layer 740, and a light-emitting device 730 electrically connected to the electrode pattern 720.

The electrode pattern 720 is made of carbon nanotube. The light-emitting device 730 is formed of an LED as in the second exemplary embodiment. The adhesive layer 740 is applied on the transparent substrate 710. The electrode pattern 720 is formed on the adhesive layer 740. The adhesive layer 740 may be formed of adhesive, polymer binder, or glass frit to conveniently combine the transparent substrate and the electrode pattern. In addition, the adhesive layer 740 may be made of adhesive which has thermo-curing, pressure-curing, ultraviolet-curing and time-curing properties.

The present embodiment exemplifies that an extra adhesive layer is formed on the transparent substrate, but is not limited thereto. It is possible to improve bonding strength between the carbon nanotube and the transparent substrate by mixing a binder highly bonded with the transparent substrate with the carbon nanotube ink.

As in the present embodiment, the adhesive layer 740 formed on the transparent substrate 710 may improve the bonding strength between the electrode pattern 720 and the transparent substrate 710, thereby forming a clearer electrode pattern.

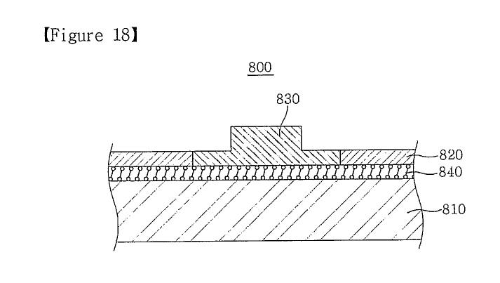

FIG. 18 is a cross-sectional view of a transparent signboard 800 according to an eighth exemplary embodiment of the present invention.

The transparent signboard 800 includes a transparent substrate 810, a functional group layer 840 formed on the transparent substrate 810, and an electrode pattern 820 formed on the functional group layer 840, and a light-emitting device 830 electrically connected to the electrode pattern 820.

The electrode pattern 820 is made of carbon nanotube. The light-emitting device 830 is formed of an LED as in the second embodiment. The functional group layer 840 acts to tightly bond the carbon nanotube to the transparent substrate, and is composed of a chemical functional group which bonds well with carboxyl group (—COOH). The chemical functional group may be one selected from among a group of amino group (—NH2), aldehyde group (—CHO), hydroxyl group (—OH), thiol group (—SH), and halogen group, or their combination.

As in the present embodiment, if the functional group layer is formed on the transparent substrate, the carbon nanotube is bonded stably with the transparent substrate.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention provides a transparent signboard and a method for fabricating the same, which is capable of forming an electrode pattern conveniently and accurately at low cost. Accordingly, the present invention can effectively be applied to industrial fields using transparent signboards for lighting or indoor/outdoor advertising.

1. A transparent signboard comprising:
a transparent substrate;
an electrode layer made of polymer and comprising a plurality of conducting parts separated from each other with respect to a predetermined pattern region interposed therebetween, and a non-conducting part formed on the predetermined pattern region and integrally formed with the conducting parts; and
a light-emitting device configured to connect the separated conducting parts to each other.

2. The transparent signboard of claim 1, wherein the polymer of the electrode layer is conductive, and the non-conducting part of the electrode layer is made non-conductive by deactivating conductive property of the polymer.

3. The transparent signboard of claim 1, wherein the polymer of the electrode layer is made of at least one of polyparaphenylene (PPP), polypyrole (PPy), polythiophene (PT), polyisothianaphthene (PITN), polyaniline (PANT), and their derivatives.

4. The transparent signboard of claim 3, wherein the non-conducting part of the electrode layer further comprises non-conductive, transparent polymer, such as acryl, urethane, melamine, epoxy, and their derivatives, in addition to the polymer of the electrode layer.

5. A method for fabricating a transparent signboard, comprising:
preparing a transparent substrate;
forming an electrode layer made of conductive polymer on the transparent substrate;
deactivating conductive property of the electrode layer on a predetermined pattern region; and
forming a light-emitting device configured to connect electrode layers separated from each other with respect to the predetermined pattern region.

6. The method of claim 5, wherein the deactivating of conductive property of the electrode layer on a predetermined pattern region comprises coating ink to deactivate the conductive property of the electrode layer on the predetermined pattern region.

7. The method of claim 6, wherein the conductive polymer is polyparaphenylene (PPP), polypyrole (PPy), polythiophene (PI), polyisothianaphthene (PITN), polyaniline (PANT), or their derivatives, and the ink is one of typical oxidants, such as sodium hypochlorite, sodium chlorite, perchloric acid (HClO4), hydrogen peroxide (H2O2), sodium perborate, and sodium peroxide.

8. The method of claim 5, wherein the deactivating of conductive property of the electrode layer on a predetermined pattern region comprises applying a laser beam to the predetermined pattern region on the electrode layer to deactivate the conductive property of the polymer.

9. The method of claim 5, wherein the deactivating of conductive property of the electrode layer on a predetermined pattern region comprises removing a conductive layer by etching the electrode layer to form a predetermined pattern.

10. The method of claim 5, further comprising drying or removing the ink following the coating of the ink.

11. A transparent signboard comprising:
a transparent substrate;
an electrode pattern formed on the transparent substrate and made of carbon nanotube; and
a light-emitting device configured to be connected to the electrode pattern.

12. The transparent signboard of claim 11, wherein the electrode pattern has a transparency of 10% to 99% and has a surface resistance ranging from 1Ω/□ (Ω per sq.) to 1MΩ/□ (MΩ per sq.).

13. The transparent signboard of claim 11, wherein the electrode pattern has a line width ranging from 1 nm to 100 μm or has a thickness ranging from 1 nm to 1 μm.

14. The transparent signboard of claim 11, wherein conductive metal is attached on a surface of the carbon nanotube, and the conductive metal comprises one selected from among a group of gold (Au), silver (Ag), copper (Cu), iron (Fe), aluminum (Al), chromium (Cr), titanium (Ti), platinum (Pt), and palladium (Pd), or their combination.

15. The transparent signboard of claim 11, wherein conductive metal is attached on a surface of the carbon nanotube, and the conductive metal comprises one selected from among a group of antimony tin oxide (ATO), indium tin oxide (ITO), indium zirconium oxide (IZO) and ZnO, or their combination.

16. The transparent signboard of claim 11, wherein a functional group layer bonding well with carboxyl group (—COOH) of the carbon nanotube is formed between the transparent substrate and the electrode pattern, and the functional group layer comprises one selected from among a group of amino group (—NH₂)> aldehyde group (—CHO), hydroxyl group (—OH), thiol group (—SH), and halogen group, or their combination.

17. The transparent signboard of claim 11, further comprising:
a supplemental substrate separated in parallel from the transparent substrate; and
a filler layer filled between the transparent substrate and the supplemental substrate.

18. The transparent signboard of claim 11, wherein a transparent adhesive layer is formed between the transparent substrate and the electrode pattern.
